(19) United States
(12) Patent Application Publication
(10) Pub. No.: US 2004/0007095 A1
(43) Pub. Date: Jan. 15, 2004

(54) Phillips head screw driver bit having cutter leading edge

(76) Inventor: Chi Fen Meng, Taichung (TW)

Correspondence Address: Chi Fen Meng, P.O. Box 63-99, Taichung, 406, TW

(21) Appl. No.: 10/195,871

(22) Filed: Jul. 12, 2002

(51) Int. Cl. B25B 13/50

(52) U.S. Cl. 81/53.2

(57) ABSTRACT

A Phillips head screw driver bit for being driven with a power tool, includes a shank having a working end for engaging with and for driving fasteners. The working end of the shank includes four slots for forming four blades each of which includes a cutter leading edge for drilling into objects, and for guiding the fasteners to be easily engaged into the objects without additional drilling tools. The cutter leading edges of the blades may engaged into the damaged or broken fasteners for forcedly removing the fasteners from the objects without additional extracting tools.

### BACKGROUND OF THE INVENTION

1. Field of the Invention

The present invention relates to a Phillips head screw driver bit, and more particularly to a Phillips head screw driver bit having a cutter leading edge.

2. Description of the Prior Art

Typical Phillips head screw driver bits may be used for driving screws or fasteners, and may not be used to drill holes into objects.

U.S. Pat. No. 3,094,893 to Lindstrom, U.S. Pat. No. 3,648,560 to Roser, U.S. Pat. No. 4,028,987 to Wilson, U.S. Pat. No. 4,697,969 to Sparkes, discloses several typical self-drilling screws or fasteners which may be easily engaged or threaded into the objects. However, the typical self-drilling screws or fasteners may not be used to rotate or to drive the other screws or fasteners.

U.S. Pat. No. 4,604,917 to Polonsky discloses a typical threaded fastener extractor which may be drilled into the fastener heads only, and which may not be used for unthreading the damaged or broken screws or fasteners.

U.S. Pat. No. 5,031,487 to Polonsky, and U.S. Pat. No. 5,251,516 to Desaulniers disclose two typical tools for extracting broken bolts or fasteners. The typical tools comprise a drilling head provided on one end of a shank for drilling into the heads of the broken fasteners, and a chuck or a tool member provided on the other end of the shank for disengaging or for removing the broken fastener from the objects.

The present invention has arisen to mitigate and/or obviate the afore-described disadvantages of the conventional Phillips head screw driver bits.

### SUMMARY OF THE INVENTION

The primary objective of the present invention is to provide a Phillips head screw driver bit including a cutter leading edge for drilling a hole into an object, for allowing the fastener to be easily screwed or threaded into the object.

The other objective of the present invention is to provide a Phillips head screw driver bit including a cutter leading edge for engaging into the broken fastener, and for easily removing the broken fastener from the object.

In accordance with one aspect of the invention, there is provided a Phillips head screw driver bit for being rotated and driven with a power tool, the Phillips head screw driver bit comprising a shank including a first end for attaching to the power tool, and including a second end for engaging with and for driving fasteners. The second end of the shank includes four slots formed therein for forming or defining four blades therebetween, the blades each includes a cutter leading edge for drilling into objects, or for engaging into the fasteners, without additional drilling tools, or without additional extracting tools.

The shank may be arranged to be rotated in an active direction and clockwise when viewing from the first end toward the second end of the shank, the cutter leading edges of the blades may thus be provided for drilling into the objects before the fasteners are engaged into the objects, for facilitating or for guiding the fasteners to be easily engaged into the objects without additional drilling tools.

The shank may be arranged to be rotated in a reverse direction and counterclockwise when viewing from the first end toward the second end of the shank, the cutter leading edges of the blades may then be provided for drilling and engaging into the fasteners for forcedly removing the fasteners from the objects without additional extracting tools.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a Phillips head screw driver bit in accordance with the present invention, having a cutter leading edge provided on the clockwise rotational direction;

FIG. 2 is an end view of the Phillips head screw driver bit as shown in FIG. 1;

FIG. 3 is a perspective view illustrating an attachment of the Phillips head screw driver bit to a power tool, so as to be rotated or driven by the power tool;

FIGS. 4, 5, 6 are exploded views illustrating the operation of the Phillips head screw driver bit;

FIG. 7 is a perspective view similar to FIG. 1, illustrating a Phillips head screw driver bit having a cutter leading edge provided on the counterclockwise rotational direction;

FIG. 8 is an end view of the Phillips head screw driver bit as shown in FIG. 7; and

FIGS. 9, 10 are exploded views illustrating the operation of the Phillips head screw driver bit as shown in FIGS. 7 and 8.

### DETAILED DESCRIPTION OF THE PREFERRED EMBODIMENT

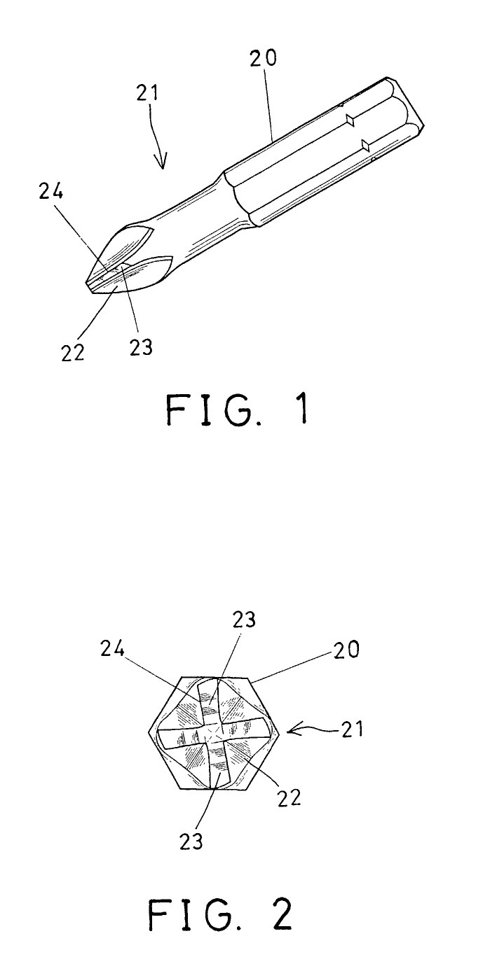

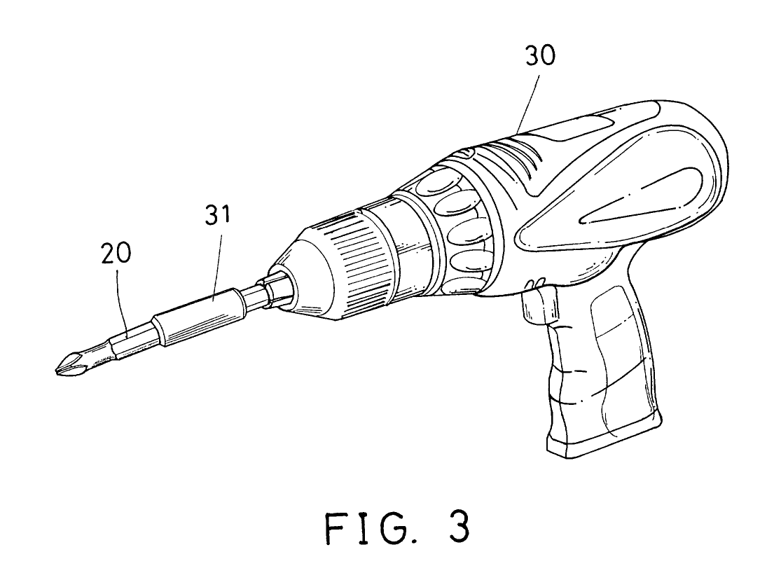

Referring to the drawings, and initially to FIGS. 1-3, a Phillips head screw driver bit in accordance with the present invention comprises a shank 20 including one end, such as a free end, for attaching to a power tool 30 directly, or indirectly via a driving stem 31, for allowing the shank 20 to be rotated or driven by the power tool 30.

The shank 20 of the Phillips head screw driver bit includes another end, such as a working end 21 having four slots 22 formed therein for forming or defining four blades 23 therebetween. The shank 20 of the Phillips head screw driver bit is arranged to be rotated in the active driving direction, or clockwise as viewing from the free end of the shank 20 toward the working end 21 of the shank 20. However, as shown in FIG. 2, the shank 20 will be rotated or driven counterclockwise.

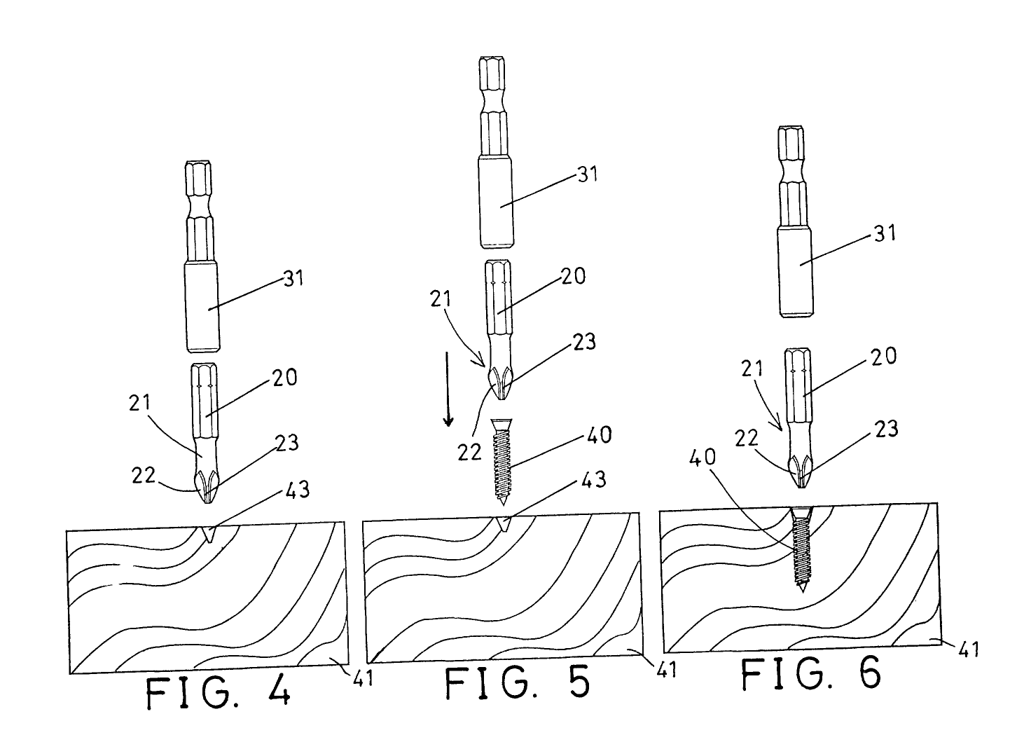

The blades 23 each includes a cutter leading edge 24 for drilling a cavity 43 in an object 41 (FIG. 4), when the shank 20 is rotated or driven clockwise or is rotated in the active driving direction by the power tool 30. As shown in FIGS. 5 and 6, the tip of the screw or the fastener 40 may then be easily guided or engaged into the cavity 43 of the object 41, and the screw or the fastener 40 may then be easily rotated and engaged into the object 41 by the shank 20 and the power tool 30.

Accordingly, the shank 20 may be used to drill the cavities 43 in the object 41 into which the screws or fasteners are to be engaged therein. The tips of the screws or the fasteners may then be guided to be stably retained in the cavities 43 of the objects 41, and may then be easily rotated or driven or engaged into the objects 41, without additional drilling tools.

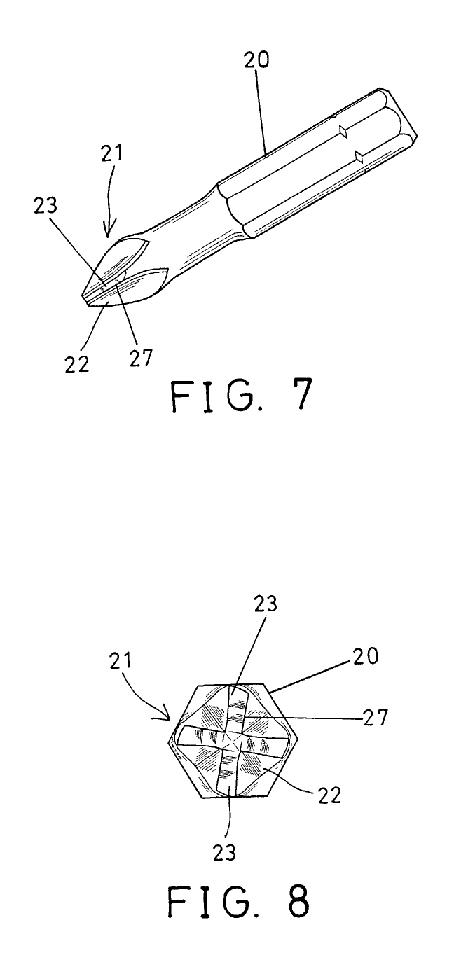

Referring next to FIGS. 7 and 8, illustrated is another Phillips head screw driver bit in accordance with the present invention which also comprises a shank 20 including one end for attaching to a power tool 30 directly, or indirectly via a driving stem 31,. for allowing the shank 20 to be rotated or driven by the power tool 30.

The shank 20 of the Phillips head screw driver bit as shown in FIGS. 7 and 8 also includes another end, such as a working end 21 having four slots 22 formed therein for forming or defining four blades 23 therebetween. The shank 20 of the Phillips head screw driver bit is arranged to be rotated in the reverse direction, or counterclockwise as viewing from the free end of the shank 20 toward the working end 21 of the shank 20. However, as shown in FIG. 8, the shank 20 will be rotated or driven clockwise.

The blades 23 each includes a cutter leading edge 27 for drilling or engaging into the damaged or broken screws or fasteners 40, or for drilling into the objects 41, when the shank 20 is rotated or driven counterclockwise, as viewing from the free end of the shank 20 toward the working end 21 of the shank 20, or is rotated in the reverse direction by the power tool 30.

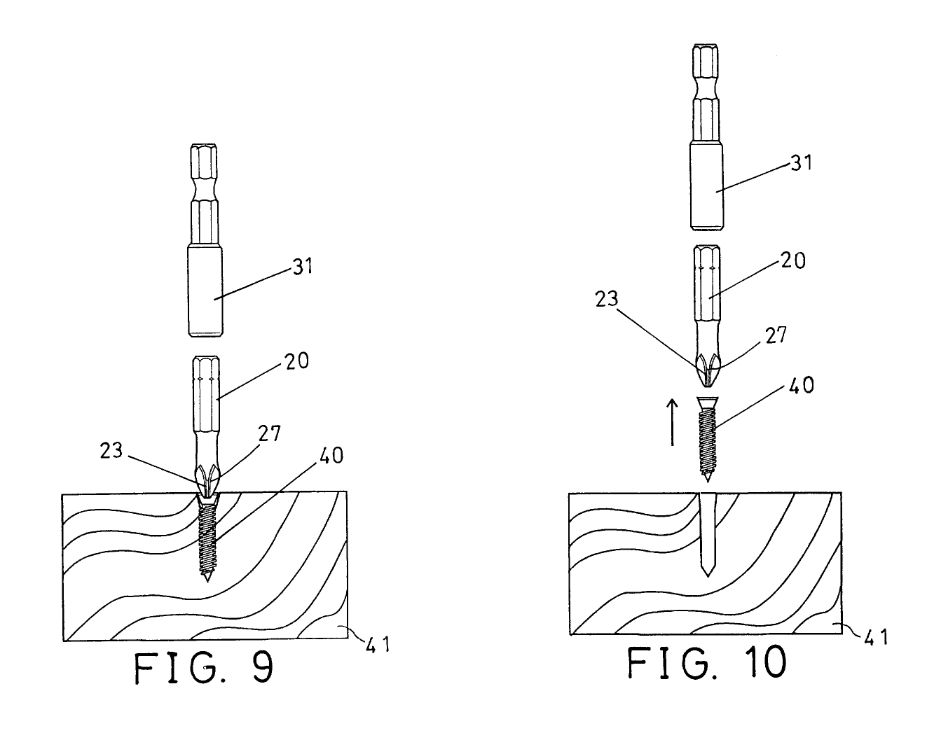

As shown in FIGS. 9 and 10, the blades 23 of the shank 20 may be engaged into the damaged or broken screw or fastener 40, particularly the damaged or broken head of the screw or fastener 40, by the cutter leading edge 27, for allowing the damaged or broken screw or fastener 40 to be easily disengaged or removed from the object 41 by the shank 20 and the power tool 30, without additional extracting tools.

It is to be noted that the blades 23 of the shank 20 may be easily and directly engaged into the damaged or broken screw or fastener 40, by the cutter leading edge 27, in order to forcedly remove the damaged or broken screw or fastener 40 from the object 41 without additional extracting tools.

Accordingly, the Phillips head screw driver bit in accordance with the present invention includes a cutter leading edge for easily rotating or driving the fasteners into the objects without additional drilling tools, or for forcedly removing the damaged or broken screw or fastener from the object without additional extracting tools.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A Phillips head screw driver bit for being rotated and driven with a power tool, said Phillips head screw driver bit comprising:
a shank including a first end for attaching to the power tool, and including a second end for engaging with and for driving fasteners, said second end of said shank including four slots formed therein for forming or defining four blades therebetween, said blades each including a cutter leading edge for drilling into objects, or for engaging into the fasteners.

2. The Phillips head screw driver bit according to claim 1, wherein said shank is arranged to be rotated in an active direction and clockwise when viewing from said first end toward said second end of said shank, said cutter leading edges of said blades are provided for drilling into the objects before the fasteners are engaged into the objects.

3. The Phillips head screw driver bit according to claim 1, wherein said shank is arranged to be rotated in a reverse direction and counterclockwise when viewing from said first end toward said second end of said shank, said cutter leading edges of said blades are provided for drilling and engaging into the fasteners for forcedly removing the fasteners from the objects.
